(19) United States
(12) Patent Application Publication
(10) Pub. No.: US 2009/0077519 A1
(43) Pub. Date: Mar. 19, 2009

(54) Displacement Aware Optical Proximity Correction For Microcircuit Layout Designs

(76) Inventor: Le Hong, Wilsonville, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/212,183

(22) Filed: Sep. 17, 2008

Related U.S. Application Data
(60) Provisional application No. 60/973,085, filed on Sep. 17, 2007.

(51) Int. Cl. G06F 17/50

(52) U.S. Cl. 716/11

(57) ABSTRACT

Techniques for adjusting edge segments within a layout design such that fewer iterations of an optical proximity correction process are required for covergence are provided. With various implementations, multiple iterations of an optical proximity correction process are performed on a portion of a layout design. The final displacement of various edge segments within a layout design may be employed to adjust the displacement of like edge segments within the same or alternate layout design, such that the optical proximity correction process may converge upon a suitable solution in fewer iterations.

### RELATED APPLICATIONS

This application claims priority under 35 U.S.C. § 119(e) to U.S. Provisional Patent Application No. 60/973,085 entitled “A Generic Technique for Reducing OPC Iteration: Fast Forward OPC” filed on Sep. 17, 2008, and naming Le Hong et al. as inventors, which application is incorporated entirely herein by reference.

### FIELD OF THE INVENTION

The invention relates to the field of photolithographic processing. More particularly, various aspects of the invention relate to reducing the number of iterations required for performing optical proximity correction (OPC) on microcircuit layout designs.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

IC layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits. Once the microcircuit device design is finalized, the layout portion of the design can be used by fabrication tools to manufacturer the device using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask or reticle based upon the layout design data, after which the mask can be used in a photolithographic process. The image created in the mask is often referred to as the intended or target image, while the image created on the substrate, by employing the mask in the photolithographic process is referred to as the printed image.

As designers and manufacturers continue to increase the number of circuit components in a given area and/or shrink the size of circuit components, the shapes reproduced on the substrate (and thus the shapes in the mask) become smaller and are placed closer together. This reduction in feature size increases the difficulty of faithfully reproducing the image intended by the layout design onto the substrate. Adding to the difficulty associated with increasingly smaller feature size is the diffractive effects of light. As light illuminates the mask, the transmitted light diffracts at different angles in different regions of the mask. These effects often result in defects where the intended image is not accurately “printed” onto the substrate during the photolithographic process, creating flaws in the manufactured device.

To address this problem, one or more resolution enhancement techniques are often employed to improve the resolution of the image that the mask forms on the substrate during the photolithographic process. Examples of various resolution enhancement techniques are discussed in “Resolution Enhancement Technology: The Past, the Present, and Extensions for the Future,” Frank M. Schellenberg, Optical Microlithography XVII, edited by Bruce W. Smith, Proceedings of SPIE Vol. 5377, which article is incorporated entirely herein by reference. One of these techniques, radiation amplitude control, is often facilitated by modifying the layout design data employed to create the lithographic mask. One way to implement this technique, for example, is to adjust the edges of the geometric elements in the layout design so that the mask created from the modified layout data will control the radiation amplitude in a desired way during a lithographic process. The process of modifying the layout design data in this manner is often referred to as “optical proximity correction” or “optical process correction” (OPC).

As previously noted, a layout design is made up of a variety of geometric elements, which typically are polygons. In a conventional optical proximity correction process, the edges of these polygons are fragmented. More particularly, the individual edges of each polygon are divided into smaller sections, often referred to as edge segments or edge fragments. The size of the fragments and the particular edges to be fragmented are dependent upon parameters of the optical proximity correction process. The fragmenting of edges facilitates the optical proximity correction process by allowing the edge segments to be rearranged or edited to realize the desired modifications. Additionally, geometric features that will increase the fidelity of the photolithographic process may be added to the design by moving or displacing the fragments. For example, some optical proximity correction processes will reconfigure the edge segments of a polygon to create serifs at one or more corners.

Optical proximity correction is an iterative process. That is, the lithographic process that will be used to manufacture the integrated circuit is simulated to determine if the simulated printed image matches the intended printed image. Modifications are made to the layout design based upon the simulation results, and the lithograph process is simulated again. When the simulated printed image cannot be substantially improved by further displacement of the edge segments, it is often said that the optical proximity correction process has converged. This process of simulation, modification, and simulation is repeated until the simulated printed image significantly corresponds to the intended printed image, or until the optical proximity correction process has converged.

Layout designs can be very large. For example, one layout data file for a single layer of a field programmable gate array may be approximately 58 gigabytes. Accordingly, performing even a single iteration of an optical proximity correction process on a design is computationally intensive. Repeating the optical proximity correction process until the simulated printed image matches the intended printed image, or until the optical proximity process has converged, only adds to the time required to finalize the layout design. Often, it can take as many as eight iterations for an optical proximity correction process to converge. Due to the number of iterations of optical proximity correction required and the complexity and size of modern layout designs, even when employing advanced computer processing techniques, the time required to perform optical proximity correction is often measured in days.

### SUMMARY OF THE INVENTION

Aspects of the present invention relate to techniques for reducing the number of iterations required to have an optical proximity correction process converge upon a suitable solution.

Various implementations of the present invention provide methods for adjusting edge segments within a layout design such that fewer iterations of an optical proximity correction process are required for covergence. With some implementations, multiple iterations of an optical proximity correction process are performed on a portion of a layout design. The displacement of various edge segment within the subportion is recorded at each iteration of the optical proximity correction process, including the final displacement. Furthermore, the various edge segments within the subportion are categorized according to type. The categorization of edge segments within the subportion along with their final displacement then are used to adjust the edge segments within the layout design.

In some implementations, a select number of iterations of the optical proximity correction process are performed upon the remainder of the layout design prior to the edge segments being adjusted. With still other implementations of the invention, the optical proximity process is performed on the remainder of the layout design after the edge segments have been adjusted based upon the recorded final displacement for like categorized edge segments. In further examples of the invention, the displacement of particular types of edge segments in a first layout design is used to adjust edge segments in a second layout design.

These and additional aspects of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an example computing environment;

FIG. 2 illustrates a layout design feature;

FIG. 3 illustrates a layout design feature;

FIG. 3A illustrates a portion of the layout design feature of FIG. 3, shown in further detail;

FIG. 3B illustrates the portion of the layout design feature of FIG. 3A, shown in further detail;

FIG. 3C illustrates the layout design feature of FIG. 3, shown in further detail;

FIG. 3D illustrates the layout design feature of FIG. 2, modified by an optical proximity correction process;

FIG. 4 illustrates a method of altering a layout design;

FIG. 4A illustrates the method of FIG. 4, shown in further detail;

FIG. 4B illustrates the method of FIG. 4, shown in further detail;

FIG. 5 illustrates an apparatus for altering a layout design;

FIG. 6 illustrates operations for altering a layout design;

FIG. 7 illustrates a plurality of edge segments of a layout design feature;

FIG. 7A illustrates an edge segment of the layout design feature of FIG. 7, shown in further detail;

FIG. 7B illustrates an entry from an associative array;

FIG. 8 illustrates a portion of a layout design feature;

FIG. 8A illustrates a portion of the layout design feature of FIG. 8, shown in further detail;

FIG. 8B illustrates the portion of the layout design feature of FIG. 8A, shown in further detail;

FIG. 9 illustrates operations for altering a layout design.

### DETAILED DESCRIPTION OF ILLUSTRATIVE EMBODIMENTS

The disclosed technology includes all novel and unobvious features, aspects, and embodiments of the systems and methods described herein, both alone and in various combinations and sub-combinations thereof. The disclosed features, aspects, and embodiments can be used alone or in various novel and unobvious combinations and sub-combinations with one another.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Optical Proximity Correction Computing Environment

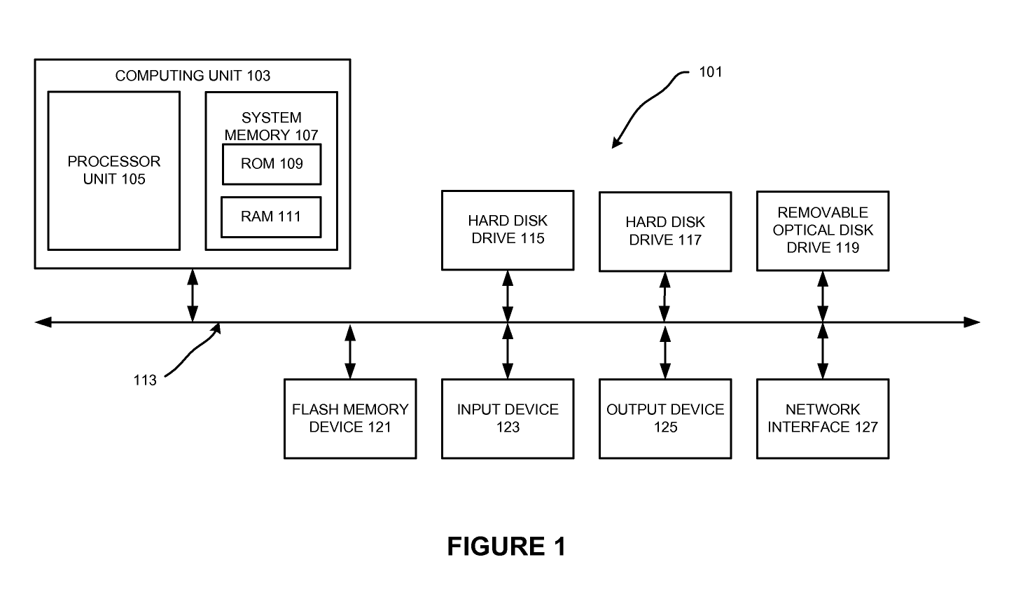

As described above, various examples of the invention may be implemented through the execution of software instructions by a computing device, such as a programmable computer. Accordingly, FIG. 1 illustrates an example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor or a combination of two or more microprocessors. The system memory 107 may include both a read only memory (ROM) 109 and a random access memory (RAM) 111. As will be appreciated by those of ordinary skill in the art, both the read only memory 109 and the random access memory 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a fixed magnetic disk drive 115, a removable magnetic disk drive 117, an optical disk drive 119, or a flash memory device 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) or the Internet protocol (IP). Also, the network interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and is not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multiprocessor computer, a plurality of single processor computers arranged into a network, a plurality of multiprocessor computers arranged into a network, or some combination of both.

### Optical Proximity Correction

In a photolithographic process, as explained above, electromagnetic radiation is transmitted through selectively transparent areas of a mask. The radiation passing through these transparent areas then irradiates desired portions of a photoresistive material on a layer of semiconductor substrate. The mask in turn is created from layout design data describing the geometric features that should be manufactured on the semiconductor substrate, by way of the photolithographic process, in order to create the desired circuit. For example, if a transistor should have a rectangular gate region, then the layout design data will include a rectangle defining that gate region. This rectangle in the layout design data is then implemented in a mask for “printing” the rectangular gate region onto the substrate.

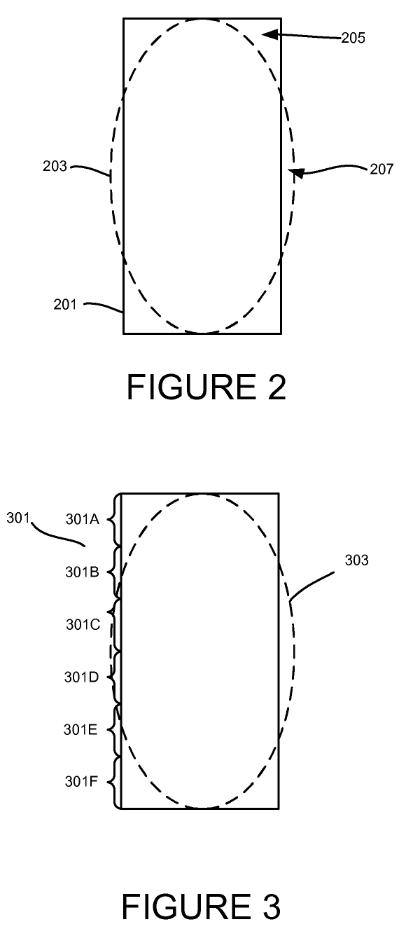

During a photolithographic process, however, optical effects will prevent the shapes defined by the mask from being faithfully imaged onto the substrate. Diffractive effects, for example, may distort the image produced by a mask. Moreover, these distortions become more pronounced as the images produced by the mask become smaller relative to the wavelength of radiation used in the photolithographic process. Thus, the rectangular mask feature 201 illustrated in FIG. 2 may produce only the image 203. As seen in this figure, the image 203 is substantially narrower in the corners (e.g., corner 205) than the ideal rectangular shape intended by the mask feature 201. Likewise, the image 203 may have areas (e.g., 207) that extend beyond the ideal rectangular shape intended by the mask feature 201. The intended shape or feature often is referred to as the target shape, or the target image. Ideally, the target image corresponds to the mask feature 201. The image created by employing the mask in a photolithographic process is often then referred to as the printed image.

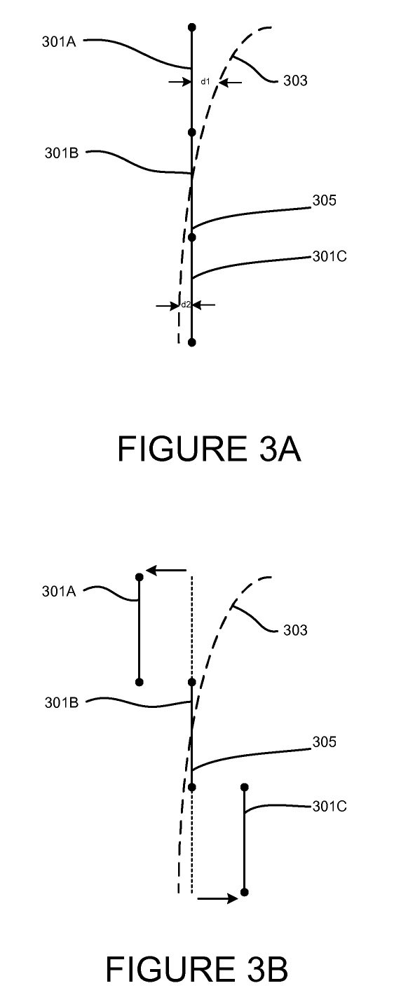

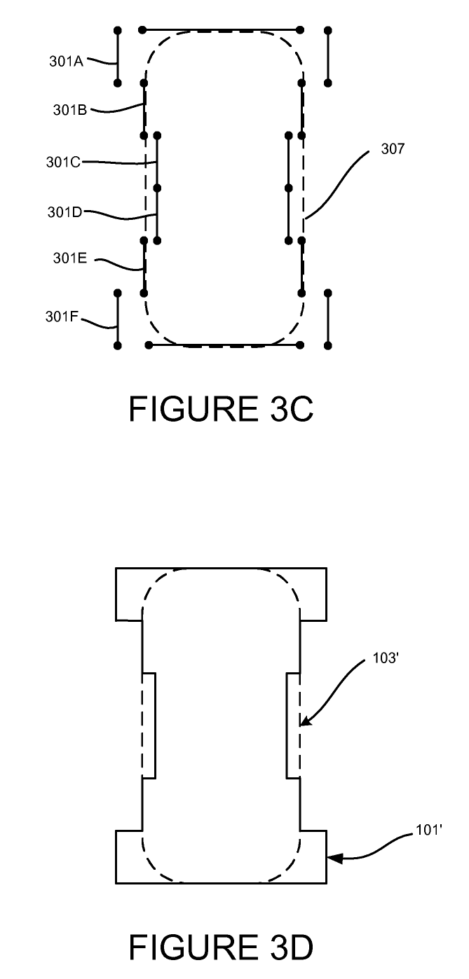

To correct for these optical distortions, many circuit designers will attempt to modify the layout design data, producing modified mask features, to enhance the resolution of the images that will be produced by the modified mask during the photolithographic process. Thus, some designers will employ an optical proximity correction (OPC) process on the layout design data, in an effort to better control the amplitude and phase of the radiation transmitted by the mask at specific locations. In a conventional optical proximity correction process, the edges of the geometric elements in the design are fragmented. For example, as shown in FIG. 3, an edge of the geometric element 301, which may be used to create the mask feature 201, is fragmented into edge segments 301A-301F. The partitioning of edge segments within a given layout design depends upon the specific optical proximity correction process parameters, often referred to as the optical proximity correction “recipe.” The recipe specifies, among other factors, the size of the edge segments. Accordingly, not all edges within a layout design will be fragmented in every optical proximity correction process. Additionally, the size of the edge segments resulting from fragmenting the polygon edges within a layout design can vary depending upon the layout design, the optical proximity correction process, or the optical proximity correction process recipe.

In attempting to correct for optical distortions within the photolithographic process, the optical proximity correction process simulates the printed image. That is, the photolithographic process is simulated in order to produce a simulated printed image. FIG. 3A illustrates a simulated printed image 303 and a target image 305, corresponding to a portion of the mask feature 301 of FIG. 3. This simulated image 303 is compared to the target image 305. Typically, this comparison is done at each edge segment. For example, as shown in FIG. 3A, the target image 305 is a distance d1 away from the simulated printed image 303 at the edge segment 301A, the target image 305 is a distance d2 away from the simulated printed image 303 at the edge segment 301C, while the target image 305 intersects the simulated printed image 303 at the edge segment 301B. The distances between the target image 305 and the simulated printed image 303 are often referred to as the edge placement error (EPE). Accordingly, in most conventional optical proximity correction processes, each edge segment, as well as each unfragmented edge, will have an associated edge placement error.

Next, the edge segments are individually moved in order to improve the resolution of the simulated printed image for the resulting mask. For example, as shown in FIG. 3B, the edge segment 301A is displaced in a direction away from the target image 305, in an effort to widen the corresponding portion of the image that would be produced by the resulting mask at the location of the edge segment 301A. Similarly, the edge segment 301C is displaced in a direction away from the target image 305, in an effort to narrow the corresponding portion of the image that would produced by the resulting mask at the location of the edge segment 301C. With various implementations of the invention, the displacement value will be a vector. More particularly, a displacement value will contain a distance component and a direction component.

This process of simulating the image that would be produced using the mask feature, comparing the simulated image to the target image, and moving edge segments accordingly may be repeated a number of times. Each cycle of simulation, compare, and move is referred to as an iteration of the optical proximity correction process. Typically, selecting edge segments to be moved during a given iteration, and the distance the edge segments are displaced, are determined based upon the edge placement errors for the edge fragment. For example, an optical proximity correction process may move an edge segment some factor of the edge placement error for that edge fragment away from the simulated printed image or the target image. Additionally, each edge segment may be displaced the same distance during a given iteration. The specific parameters that control edge movement are dependent upon the tool used to implement the optical proximity correction process and the optical proximity correction process recipe.

Typically, the optical proximity correction process is allowed to iterate until the simulated image is sufficiently similar to the target image (e.g., both d1 and d2 are smaller than a threshold value), or until it is determined that the edge segments have converged on locations where no further movement of the edge segments will improve the simulated image. FIG. 3C shows the geometric element 301 of FIG. 3, with the edges fragmented and displaced, along with a simulated printed image 307 based upon the displaced edge segments. Once the final positions of the edge segments are determined in the layout design data as shown in FIG. 3C, a modified mask feature can be created from the corrected layout design data. FIG. 3E shows a modified mask feature 101′, produced from the displaced edge segments of FIG. 3D. Additionally, the image 103′ produced by the modified mask feature 101′ is shown. FIG. 3E illustrates that the modified mask feature 101′ produces an image that more closely correspond to the target image.

### Displacement Aware Optical Proximity Correction

As stated above, optical proximity correction is an iterative process. The number of iterations required for the process to converge on a suitable solution may be eight to ten iterations or more, depending upon the layout design and the “recipe”. Even with advanced computing resources, sophisticated optical proximity correction tools, and good recipes, the time needed to perform eight to ten iterations is typically a few days. One reason for the high number of required iterations is due to fragments oscillating around a final target. Without carefully designed feedback processes individual to a particular layout design, edge segments will typically oscillate around the final target further adding to the number of iterations required for the process to converge. Another reason that the number of required iterations is high is due to the differing speed with which different types of edge segments converge. For example, with some layout designs the short edge segments forming the end edge between two longer edges (typically called line end fragments) converge much slower than other types of edge segments within the layout design do.

With some implementations of the invention, the edge fragment movements are observed and tracked while optical proximity correction is applied to a small portion or “clip” of a layout design. The tracked movements are used to speed the rate of convergence while optical proximity correction is applied to the balance of the layout design. For example, the observed final displacement for selected categories of edge segments can be used to “fast forward” the movements or displacement of similarly categorized edge segments.

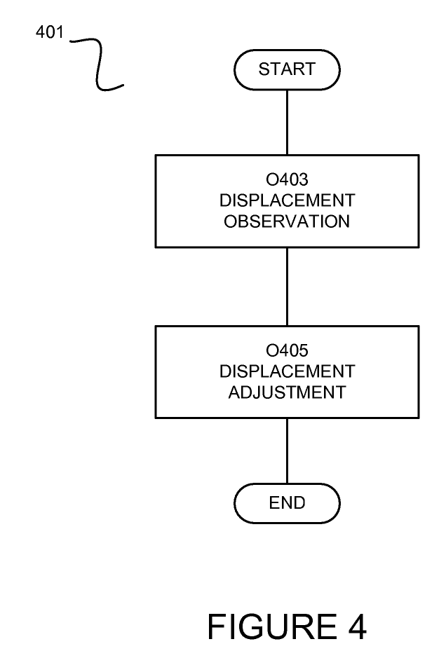

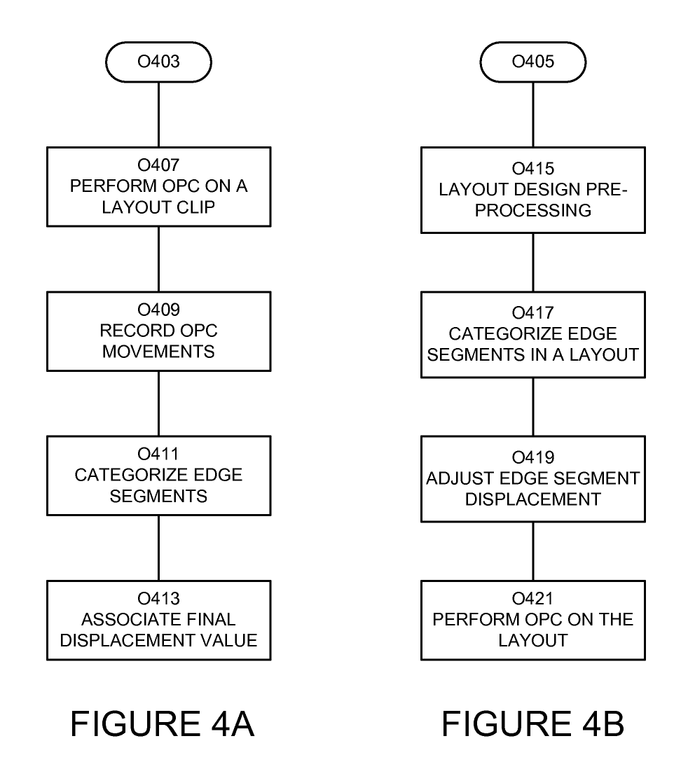

FIG. 4 illustrates a method of adjusting a layout design for a mask according to various implementations of the invention 401. The method 401 is broken down into two operations. The first operation, operation 403 calls for observing the displacement of selected types or “classes” of edge segments during an optical proximity correction process. The second operation, operation 405 adjusts the edge segment displacement of the selected types of edge segments based upon the observations made during the operation 403.

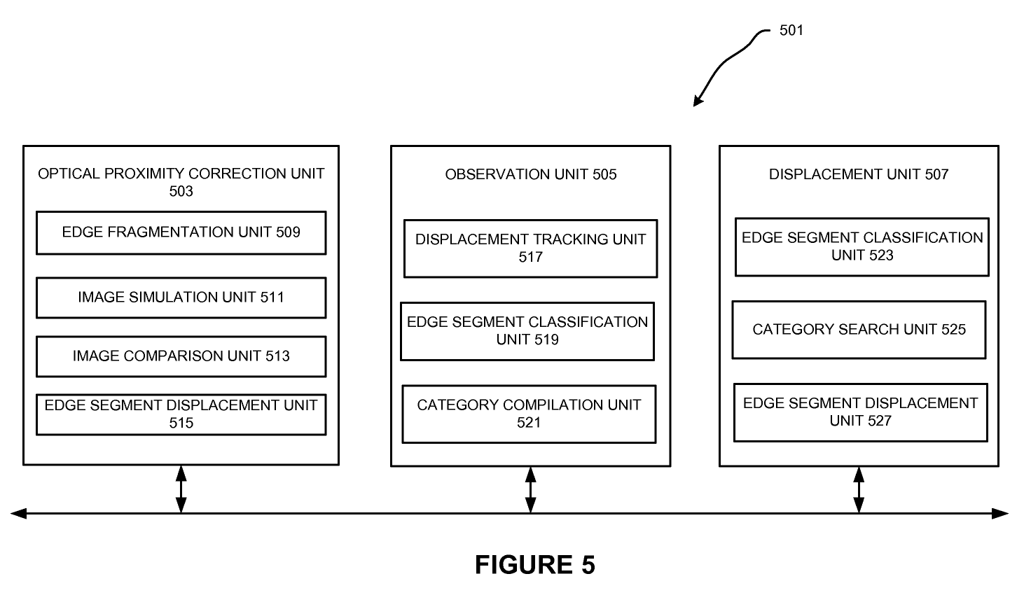

FIGS. 4A and 4B illustrate in more detail operations that may be employed to implement, according to various embodiments of the present invention, the displacement observation operation 403 and the displacement adjustment operation 405 of FIG. 4 respectively. FIG. 5 illustrates a displacement aware optical proximity correction tool 501 that may be implemented according to various embodiments of the present invention to perform the methods described by FIGS. 4, 4A, and 4B. The tool 501 includes an optical proximity correction unit 503, an observation unit 505, and a displacement unit 507.

With some implementations of the invention, the optical proximity correction unit 503 is a conventional optical proximity tool. For example, embodiments of the present invention may be implemented in conjunction with the Calibre optical proximity correction tools by Mentor Graphics Corporation of Wilsonville, Oreg. In other implementation of the invention, the optical proximity correction tool 503 is one designed specifically for use by the displacement aware correction tool 501. As seen in FIG. 5, the optical proximity correction unit 503 includes an edge fragmentation unit 509, an image simulation unit 511, an image comparison unit 513, and an edge segment displacement unit 515. The units 509-515 of the optical proximity correction unit 503 provide the functionality needed for a layout design to be iteratively adjusted by an optical proximity correction process as discussed above. Those of skill in the art will appreciate that various tools exist for performing optical proximity correction, and the unit 503 is but one implementation of them.

### Displacement Aware Optical Proximity Correction Categorization

As described in detail above, optical proximity correction is an iterative process whereby edges in a layout design are partitioned into edge segments and the edge segments are displaced. As the specifics of optical proximity correction have already been discussed in detail above, the detailed implementations of the optical proximity correction processes employed by various implementations of the invention have been omitted from the balance of this disclosure. Instead, general operations germane to an optical proximity correction process, for example, edge segment, displacement, iteration, or convergence are used to describe the optical proximity correction operations implemented with various embodiments of the present invention. These abstract descriptions are to be interpreted in light of the above description of optical proximity correction and the accompanying figures, as well as the knowledge possessed by those of ordinary skill in the art related to optical proximity correction and the photolithographic process.

As described above, FIG. 4 illustrates the method 401 directed to adjusting a layout design for a mask. The operation 403 of the method 401 calls for observing the displacement of selected types or “classes” of edge segments during an optical proximity correction process of a sub-portion of a design such that the observations may later be applied to reduce the iterations needed for an optical proximity correction process to converge edge fragments in the remainder of the design. As shown in FIG. 4A, with various implementations of the invention, the operation 403 includes an operation 407 for performing optical proximity correction on a selected portion of a layout design, an operation 409 for recording the edge segment movements during the optical proximity correction of the operation 407, an operation 411 for categorizing the edge segments within the selected portion of the layout design, and an operation 413 for associating a final edge segment displacement value with each edge segment category.

With some implementations of the invention, a tool such as the displacement aware optical proximity correction tool 501 may be employed to perform the method detailed in FIG. 4. As previously noted, the displacement aware optical proximity correction tool 501 may be implemented by, for example, executable software instructions embodied in a computer-readable medium or by a computer executing software instructions for performing the functions of the optical proximity correction tool 501. As seen in FIG. 5, the displacement aware optical proximity correction tool 501 includes an optical proximity correction unit 503, an observation unit 505, and a displacement unit 507. The observation unit 505 includes a displacement tracking unit 517, an edge segment classification unit 519 and a category compilation unit 521. In various implementations, the optical proximity correction unit 503 performs the operation 407 while the observation unit 505 performs the operations 409 and 411. For example, during the optical proximity correction process of operation 407, the displacement tracking unit 517 may record the movements of each displaced edge segment. More particularly, during the optical proximity correction process, as the various edge segments are displaced during an iteration of the optical proximity correction process, the displacement value will be recorded by the displacement tracking unit 517. With some implementations, only those movements corresponding to a select number of iterations are recorded. Still, with other implementations, the movements associated with all iterations are recorded. Further still, with some implementations, only the final movement value, associated with the last iteration is recorded.

Once the operation 407 and the operation 409 of performing optical proximity correction on a select portion of a layout design and recording the edge segment movements is complete, categorizing the edge segments is initiated by the operation 411. The edge segment classification unit 519 of the displacement aware optical proximity correction tool 501 may be used to perform the operation 411. With some implementations, the edge segments will have been categorized by the optical proximity correction process. More particularly, some optical proximity correction processes categorize the edge segments as part of the optical proximity correction process. For example, the edge segments may be categorized as a line end, an edge, or a corner segment.

With other implementations of the invention, the edge segments may be categorized based upon the length of the segments. With still other implementations, the edge segments may be categorized by the type of corners associated with the edge segments. With yet other implementations of the invention, the edge segments may be categorized by the length and the edge segment corner types. As an example, some implementations of the invention will assign a value to each edge segment corner type. For example, an edge segment without a corner may be assigned a value of 0, a convex corner may be assigned a value of 1, and a concave corner a may be assigned a value of 2. More particularly, the edge segment 301A of FIG. 3 has a convex corner at its upper end and no corner at its lower end. Thus it would be assigned a value of [1,0]. While the edge segment 301B of FIG. 3 does not have a corner at either end and would be assigned the value [0,0]. As a further example, an edge segment having a convex corner at one end and a concave corner at an opposite end would be assigned the value of [1,2].

After the operation 411 is completed, the operation 413 associates a recorded final displacement with an edge segment category. With some implementations of the invention, this is accomplished at the same time that the edge segments are classified, for example, by the edge segment classification unit 519. Still with other implementations of the invention, a final displacement is associated with each edge segment category after the edge segments are categorized. For example, by a tool such as the category compilation unit 521 of the displacement aware optical proximity correction tool 501. In various implementations of the invention, the recorded final displacement associated with a select edge segment category is the average of all the recorded final displacements for the edge segments within the selected category. With other implementations, the recorded final displacement associated with a select edge segment category is the largest recorded displacement of all the recorded final displacements for the edge segments within the selected category. Still, with other implementations, the recorded final displacement associated with a select edge segment category is the smallest of all the recorded final displacements for the edge segments within the selected category.

With still further implementations of the invention, an associative array or “look up table” may be compiled from the edge segment categories and associated final displacements. For example, the category compilation unit 521 of the displacement aware optical proximity correction tool 501 might compile an associative array of key value pairs. Wherein each key would correspond to an edge segment category and each value would correspond to the associated final displacement for the category.

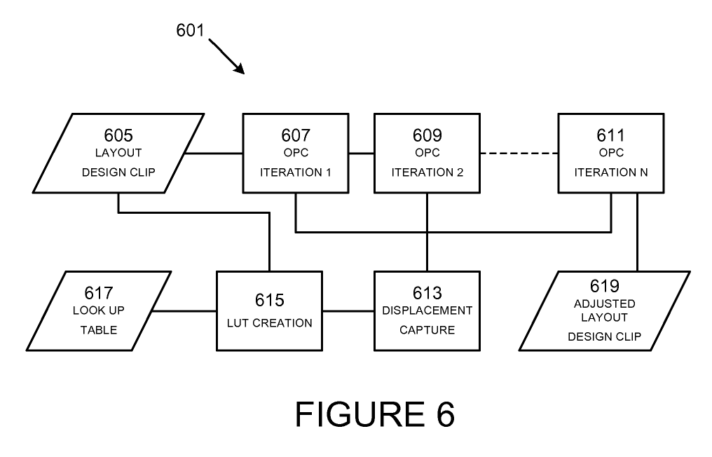

FIG. 6 illustrates a displacement aware categorization process 601 that may be executed according to various implementations of the present invention. As can be seen in FIG. 6, the displacement aware categorization process 601 includes a select sub-portion of a layout design, or a layout design “clip” 605. The displacement aware categorization process 601 includes an operation for performing a first iteration 607 of an optical proximity correction process on the layout design clip 605, an operation for performing a second iteration 609 of the optical proximity correction process on the layout design clip 605, operations for performing subsequent iterations of the optical proximity correction process on the layout design clip 605, including a final iteration 611 of the optical proximity correction process. Executing the optical proximity correction process on the layout design clip 605 results in the adjusted layout design clip 619. With various implementations of the invention, the adjusted layout design clip 619 is saved to a memory storage location.

The displacement aware categorization process 601 further includes an operation 613 for capturing the displacements of selected edge segments during the optical proximity correction process. As can be seen in FIG. 6, the operation for capturing displacements 613 records the displacement for the first iteration 607, the second iteration 609 and the final iteration 611. With some implementation of the invention, only those edge segment displacements from the final iteration will be recorded. With other implementations of the invention, the edge segment displacements from a select number of iterations including the final iteration will be recorded. With still other implementations of the invention, the edge segment displacements from all iterations will be recorded. With still further implementations of the invention, the edge segment displacements for selected iterations of the invention, not including the final iteration are recorded. As seen in FIG. 6, the displacement aware categorization process 601 also includes an operation for creating a look up table 615, which results in the creation of a look up table 617.

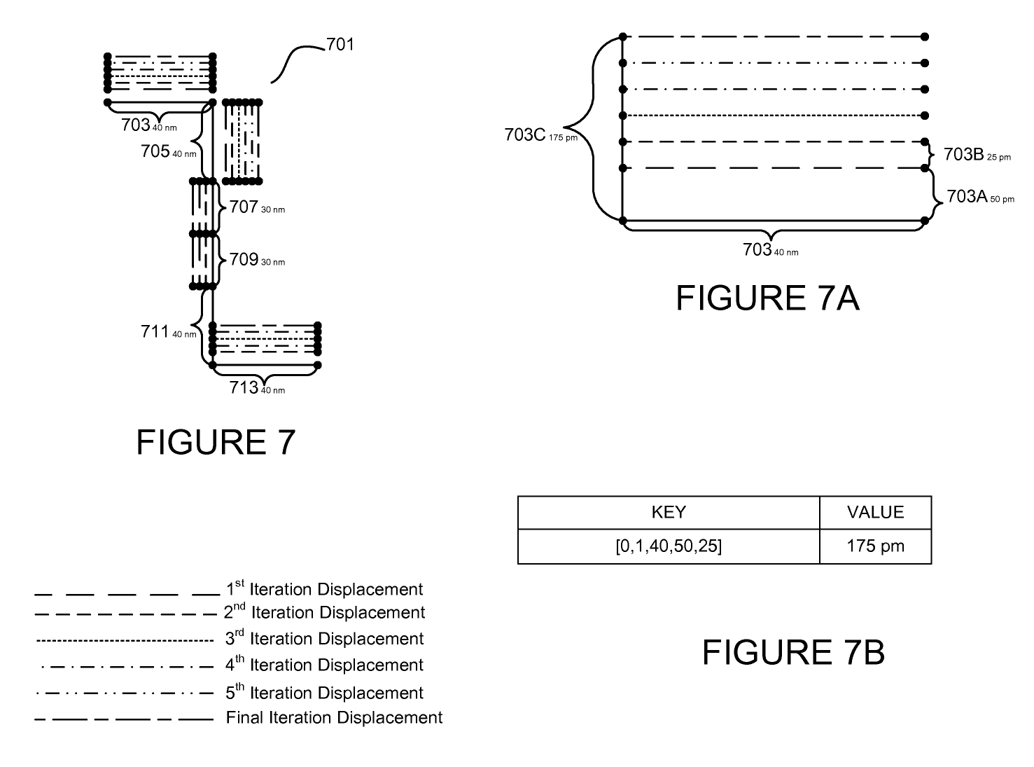

FIG. 7 illustrates a portion of a layout design feature 701 from the layout design clip 605. The displacement aware optical proximity correction tool 501 may be used to execute the displacement aware categorization process 601 on the layout design clip 605, including the portion of the layout design feature 701. The optical proximity correction unit 503 might be used to perform optical proximity correction on the portion of the mask feature 701, including the first iteration 607, the second iteration 609 and the final iteration 611. As can be seen in FIG. 7, the edges of the mask feature 701 have been partitioned into edge segments 703-713, and various edge segment displacements resulting from the optical proximity correction process are also shown. Additionally, the length of the edge segments are shown as well. Those of skill in the art will appreciate that the described lengths, scale, and illustrated edge segment displacements are hypothetical and shown for purposes of clarity.

FIG. 7A illustrates the edge segment 703 and associated displacements produced by the optical proximity correction process in further detail. As can be seen in FIG. 7A, a first iteration displacement 703A resulting from the first iteration operation 607, a second iteration displacement 703B resulting from the second iteration operation 607, and a final iteration displacement 703C resulting from the final iteration operation 611 are shown. As in FIG. 7, the described lengths, scale, and illustrated edge segment displacements are hypothetical and shown for purposes of clarity. The displacement tracking unit 517 of the displacement aware optical proximity correction tool 501 may be used to execute the displacement capture operation 613 and record the first iteration displacement distance and direction 703A, the second iteration displacement distance and direction 703B, and the final iteration displacement distance and direction 703C. The edge segment classification unit 519 might be used to determine and assign a value to the corner types of the edge segment 703. For example, as described above, with some implementations of the invention, no corner type is assigned a value of 0, while a convex corner type is assigned a value of 1. Accordingly the edge segment 703 would be assigned a value of [0,1]. The category compilation unit 521 may be used in conjunction with the assigned category values generated from the edge segment classification unit 519 to execute the look up table creation operation 615 and generate the look up table 617.

FIG. 7B illustrates an example entry from a look up table that corresponds to the edge segment category for which the edge segment 703 belongs. As explained above, with some embodiments of the invention, the edge segment category is determined from the length of the edge segment. With other embodiment of the invention, the edge segment category is determined from the edge segment corner types. With still other embodiments of the invention, the edge segment category is determined based upon at least one edge segment displacement associated with a select iteration of the optical proximity correction process. With some implementations of the invention, the displacement distances associated with an edge segment and a select optical proximity correction process iteration are all measured from the original edge segment location. For example, the edge segment displacement 703C of FIG. 7A. With other implementations, the displacement distances associated with an edge segment and a select optical proximity correction process are measured from the beginning edge segment location. For example, the edge segment displacements 703A and 703B of FIG. 7A.

As can be seen in FIG. 7B, the edge segment category is determined from the combination of the edge segment corner type, the length of the edge segment and the displacements of the edge segment for the first and second iterations of the optical proximity correction process. With some implementations, the edge segment category or if using a look up table, the key value for the look up table 617 will be a plurality of values as illustrated in FIG. 7B. With other implementations of the invention, the key value might be the sum, or product of the values. With still other implementations of the invention, the key value is the sum of the individual values, with some of the values being scaled. For example, the edge segment category could be set by scaling the edge segment length by 10,000, the first edge segment corner value by 1,000,000, the second edge segment corner value by 100,000, the first iteration displacement by 10, and the second iteration displacement by 0.01. More particularly, the key value associated with the edge segment 703, according to the example model above, would be 500,500.25.

### Displacement Aware Optical Proximity Correction Layout Adjustment

As described previously, FIG. 4 illustrates the method 401 of performing optical proximity correction on a layout design. As explained, the method 401 includes the step 403 for observing the displacements of edge segments within a sub-portion of the layout design and the step 405 for adjusting the displacements within the balance of the layout design based in part on the observations of step 403. With various implementations of the invention, the operation 405 of the method 401 will be further implemented by the operations shown in FIG. 4B. As can be seen in FIG. 4B, the operation 405 includes an operation 415 for pre-processing the layout design, an operation 417 for categorizing edge segments within a layout, an operation 419 for adjusting an edge segment displacement, and an operation 421 for performing optical proximity correction on the layout.

With some implementations of the invention, the displacement aware optical proximity correction tool 501 may be used to perform the operation 405. As explained previously, the tool 501 includes an optical proximity correction unit 503, which may be employed to perform optical proximity correction on a layout design. More particularly, the optical proximity correction unit 503 may be used to perform the operations 415 and 421 of the method 405. With some implementations of the invention, the operation 415 for pre-processing the layout design will include performing a selected number of iterations of optical proximity correction on the layout design and recording various edge segment displacements during the optical proximity correction process. Still, with some implementations of the invention, the operation 417 for pre-processing the layout design will merely ensure the polygon edges within the layout design are properly fragmented into edge segments. With various implementations of the invention, the operation 417 for pre-processing the layout design will depend upon the specific method employed to classify the edge segments.

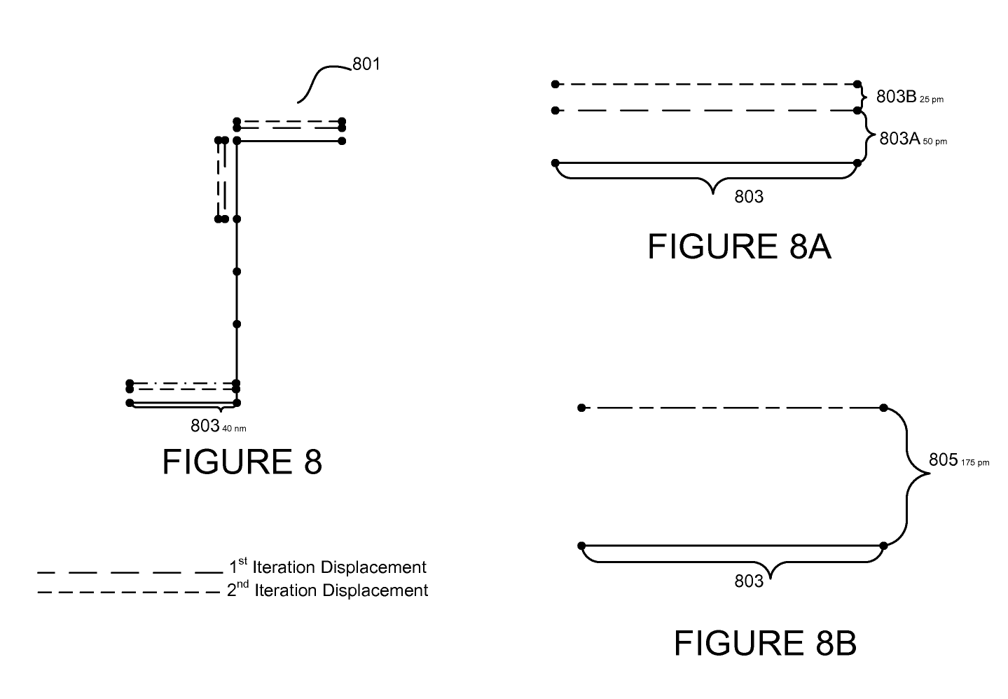

More particularly, with some implementations of the invention, the edge segments are classified based upon the length of the edge segment, the edge segment corner types, the edge segment displacement during the first iteration of optical proximity correction, and the edge segment displacement during the second iteration of optical proximity correction. Accordingly, the operation 417 for pre-processing the layout design would include performing at least two iterations of optical proximity correction on the layout design, such that the edge segments within the layout design may be properly classified. For example, FIG. 8 illustrates a portion of a layout design 801. As can be seen in FIG. 8, the polygon edges of the portion of the layout design have been fragmented into edge segments, such as the edge segment 803. Additionally, the edge segment displacements from the first two iterations of an optical proximity correction process are shown.

The edge segment classification unit 523 of the tool 501 may be employed to perform the operation 417 for categorizing the edge segments within a layout design. In some implementations of the invention, the edge segment classification unit 519 is the same as the edge segment classification unit 523, while with other implementations of the invention, the edge segment classification units 519 and 523 are separate and different apparatuses. As explained previously, some implementations categorize the edge segments within a layout design based upon the edge segment type. For example, a line end, an edge, or a corner segment. As seen in FIG. 7B, with various implementations of the invention the edge segments are categorized based upon the length of the edge segment, the edge segment corner type, the displacement from the first iteration of optical proximity correction and the displacement from the second iteration of optical proximity correction. For example, FIG. 8A illustrates the edge segment 803 along with the edge segment displacements from the first and second iterations of optical proximity correction. As can be seen in FIG. 8, the edge segment 803 has no corner at the first corner, a convex corner at the second corner, and measures 40 nanometers in length. Additionally, the edge segment displacement for the first iteration of optical proximity correction is 50 picometers and the edge segment displacement for the second iteration of optical proximity correction is 25 picometers. Accordingly, with various implementations of the invention, the edge segment classification would be [0,1,40,50,25].

Once the edge segments within the layout design are classified, the category search unit 525 and the edge segment displacement unit 527 may be employed to identify the final displacement associated to selected edge segment categories within the layout design and adjust the edge segment displacement accordingly. More particularly, the operation 413 associates a final edges segment displacement with a particular edge segment category. With the operation 419, the final displacement must be identified and applied to the particular edge segment. For example, the edge segment 803 of FIG. 8 has a category classification of [0,1,40,50,25]. This is the same category classification as the edge segment 703 from FIG. 7. The final displacement value associated with this category is 175 picometers. Accordingly, the edge segment 803 would be adjusted to have a displacement of 175 picometers, as illustrated in FIG. 8B. As can be seen in FIG. 8B, the edge segment 803 has been adjusted to position 805, having a displacement of 175 picometers. With various implementations of the invention, operations to interpolate between edge segment categories within a lookup table may be provided. More particularly, the final displacement associated with two adjacent edge segment categories may be used to provide a final displacement for an edge segment with a categorization falling between the two adjacent edge segment categories.

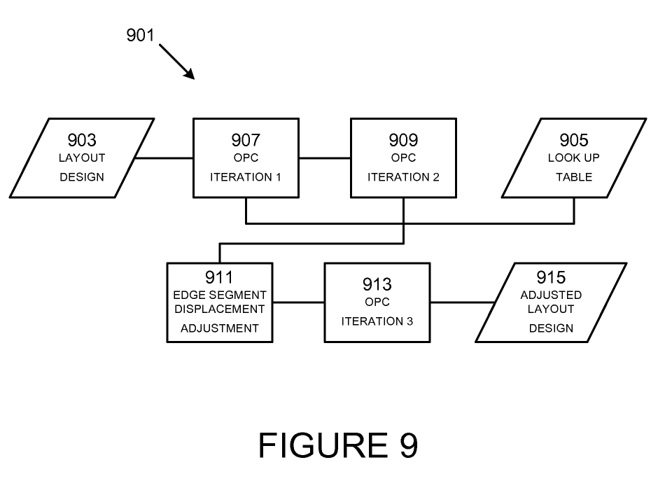

FIG. 9 illustrates a displacement aware optical proximity correction process 901 that may be executed according to various implementations of the present invention. As can be seen in FIG. 9, the displacement aware optical proximity correction process 901 includes a portion of a layout design 903 and a look up table 905. With various implementations of the invention, the look up table 905 is identical to the look up table 617 of FIG. 6. More particularly, the look up table 905 will have been generated by a process such as the displacement aware categorization process 601. Additionally, the layout design clip 603 will have been taken from the same layout design as the portion of the layout design 903 is taken. Still, with other implementations of the invention, the look up table 905 will have been generated based upon a layout design clip from a different layout design as the portion of the layout design 903. Accordingly, with various implementations of the invention, the look up table employed in the displacement aware optical proximity correction process may be reused for different layout designs.

The displacement aware optical proximity correction process 901 further includes an operation for performing a first iteration 907 of an optical proximity correction process on the layout design 903, an operation for performing a second iteration 909 of the optical proximity correction process on the layout design 903, an operation 911 for adjusting the edge segment displacements within the layout design, an operation for performing a third iteration 913 of the optical proximity correction process on the layout design, resulting in an adjusted layout design 915. With various implementations of the invention, the adjusted layout design 915 is saved to a memory storage location.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

Methods and apparatuses for altering a portion of a layout design have been shown. More particularly, techniques for reducing the number of iterations required to have an optical proximity correction process converge upon a suitable solution have been disclosed. In some implementations, multiple iterations of an optical proximity correction process are performed on a portion of a layout design. The displacement of various edge segments within the subportion are recorded at each iteration of the optical proximity correction process, including the final displacement. Furthermore, the various edge segments within the subportion are categorized according to type. The categorization of edge segments within the subportion along with their final displacement then are used to adjust the edge segments within the layout design.

In some implementations, a select number of iterations of the optical proximity correction process are performed upon the remainder of the layout design prior to the edge segments being adjusted. With still other implementations of the invention, the optical proximity process is performed on the remainder of the layout design after the edge segments have been adjusted based upon the recorded final displacement for like categorized edge segments. In further examples of the invention, the displacement of particular types of edge segments in a first layout design is used to adjust edge segments in a second layout design.

What is claimed is:

1. A method for altering a portion of a layout design comprising:
receiving a portion of a layout design, the layout design containing a plurality of polygon edges;
dividing the layout design into a first portion and a second portion;
partitioning the plurality of polygon edges in the first portion of the layout design into a plurality of edge segments;
implementing multiple iterations of an optical proximity correction process on the first portion of the layout design, each iteration of the optical proximity correction process altering the first portion of the layout design by displacing at least one of the plurality of edge segments within the first portion of the layout design;
for selected edge segments within the first portion of the layout design, categorizing each of the selected edge segments;
for an edge segment in each category of the selected edge segments, recording a displacement of the edge segment at a plurality of iterations of the optical proximity correction process, including a final displacement obtained at a final iteration of the optical proximity correction process;
partitioning the plurality of polygon edges in the second portion of the layout design into a plurality of edge segments;
for selected edge segments within the second portion of the layout design, determining to which category the edge segment corresponds;
altering the second portion of the layout design by adjusting the position of the selected edge segments based upon the final displacement associated with the determined category for the selected edge segments; and
storing the altered layout design to a memory location.

2. The method recited in claim 1, further comprising:
implementing at least one iteration of an optical proximity correction process on the second portion of the layout design, the optical proximity correction process altering the layout design by displacing at least one of the plurality of edge segments within the second portion of the layout design; and
for a selected edge segment in each category of edge segments, recording a displacement of the selected edge segment during the at least one iteration of the optical proximity correction process.

3. The method recited in claim 2, further comprising:
implementing at least one iteration of an optical proximity correction process on the altered second portion of the layout design, the optical proximity correction process further altering the second portion of the layout design by displacing at least one of the plurality of edge segments within the second portion of the layout design.

4. The method recited in claim 2, wherein the selected edge segments are categorized based in part upon the length of the edge segment and the edge segments corner types.

5. The method recited in claim 4, further comprising:
implementing an associative array corresponding to the edge segment categorization and the final displacement for each edge segment category.

6. The method recited in claim 5, the associative array containing a plurality of key value pairs;
each key corresponding to a length value, a corner value, a first iteration displacement, and a second iteration displacement of a selected edge segment; and
each value corresponding to the final displacement of the selected edge segment.

7. A method of altering a portion of a layout design, comprising:
receiving a portion of a layout design, the portion of the layout design containing a plurality of polygon edges;
partitioning the plurality of polygon edges in the portion of the layout design into a plurality of edge segments;
receiving a plurality of edge segment categorizations and a final edge segment displacement associated with each edge segment category;
for selected edge segments in the portion of the layout design,
determining to which category the edge segment corresponds,
altering the portion of the layout design by adjusting the position of the edge segment based upon the final displacement associated with the determined category for the edge segment; and
storing the altered portion of the layout design to a memory location.

8. The method recited in claim 7, further comprising:
implementing at least one iteration of an optical proximity correction process on the portion of the layout design, the optical proximity correction process altering the portion of the layout design by displacing at least a one of the plurality of edge segments in the portion of the layout design; and
for a selected edge segment in each category of edge segments,
recording a displacement of the selected edge segment during the at least one iteration of the optical proximity correction process.

9. The method recited in claim 8, further comprising:
implementing at least one iteration of an optical proximity correction process on the altered portion of the layout design, the optical proximity correction process further altering the portion of the layout design by displacing at least one of the plurality of edge segments within the portion of the layout design.

10. The method recited in claim 8, wherein the edge segment categorization is based in part upon the length of the edge segment and the edge segments corner types.

11. A computer program product for enabling a computer to alter a portion of a layout design comprising:
software instructions for enabling a computer to perform a set of predetermined operations; and
a computer readable storage medium bearing the software instructions;
the set of predetermined operations including:
accessing a portion of a layout design, the layout design containing a plurality of polygon edges;
dividing the layout design into a first portion and a second portion;
partitioning the plurality of polygon edges in the first portion of the layout design into a plurality of edge segments;
implementing multiple iterations of an optical proximity correction process on the first portion of the layout design, each iteration of the optical proximity correction process altering the first portion of the layout design by displacing at least one of the plurality of edge segments within the first portion of the layout design;
for selected edge segments within the first portion of the layout design, categorizing each of the selected edge segments;
for an edge segment in each category of the selected edge segments, recording a displacement of the edge segment at a plurality of iterations of the optical proximity correction process, including a final displacement obtained at a final iteration of the optical proximity correction process;
partitioning the plurality of polygon edges in the second portion of the layout design into a plurality of edge segments;
for selected edge segments within the second portion of the layout design, determining to which category the edge segment corresponds;
altering the second portion of the layout design by adjusting the position of the selected edge segments based upon the final displacement associated with the determined category for the selected edge segments; and
storing the altered layout design to a memory location.

12. The computer program product recited in claim 11, further comprising software instructions for enabling a computer to perform the following operations:
implementing at least one iteration of an optical proximity correction process on the second portion of the layout design, the optical proximity correction process altering the layout design by displacing at least one of the plurality of edge segments within the second portion of the layout design; and
for a selected edge segment in each category of edge segments, recording a displacement of the selected edge segment during the at least one iteration of the optical proximity correction process.

13. The computer program product recited in claim 12, further comprising software instructions for enabling a computer to perform the following operations:
implementing at least one iteration of an optical proximity correction process on the altered second portion of the layout design, the optical proximity correction process further altering the second portion of the layout design by displacing at least one of the plurality of edge segments within the second portion of the layout design.

14. The computer program product recited in claim 12, wherein the selected edge segments are categorized based in part upon the length of the edge segment and the edge segments corner types.

15. The computer program product recited in claim 14, further comprising software instructions for enabling a computer to perform the following operations:
implementing an associative array corresponding to the edge segment categorization and the final displacement for each edge segment category.

16. The computer program product recited in claim 15, the associative array containing a plurality of key value pairs;
each key corresponding to a length value, a corner value, a first iteration displacement, and a second iteration displacement of a selected edge segment; and each value corresponding to the final displacement of the selected edge segment.

17. A computer system adapted to alter a portion of a layout design comprising:
a processor; and
a memory including software instructions that cause the computer system to perform operations including:
accessing a portion of a layout design, the layout design containing a plurality of polygon edges;
dividing the layout design into a first portion and a second portion;
partitioning the plurality of polygon edges in the first portion of the layout design into a plurality of edge segments;
implementing multiple iterations of an optical proximity correction process on the first portion of the layout design, each iteration of the optical proximity correction process altering the first portion of the layout design by displacing at least one of the plurality of edge segments within the first portion of the layout design;
for selected edge segments within the first portion of the layout design, categorizing each of the selected edge segments;
for an edge segment in each category of the selected edge segments, recording a displacement of the edge segment at a plurality of iterations of the optical proximity correction process, including a final displacement obtained at a final iteration of the optical proximity correction process;
partitioning the plurality of polygon edges in the second portion of the layout design into a plurality of edge segments;
for selected edge segments within the second portion of the layout design, determining to which category the edge segment corresponds;
altering the second portion of the layout design by adjusting the position of the selected edge segments based upon the final displacement associated with the determined category for the selected edge segments; and
storing the altered layout design to a memory location.

18. The computer system recited in claim 17, further comprising software instructions for:
implementing at least one iteration of an optical proximity correction process on the second portion of the layout design, the optical proximity correction process altering the layout design by displacing at least one of the plurality of edge segments within the second portion of the layout design; and
for a selected edge segment in each category of edge segments, recording a displacement of the selected edge segment during the at least one iteration of the optical proximity correction process.

19. The computer system recited in claim 18, further comprising software instructions for:
implementing at least one iteration of an optical proximity correction process on the altered second portion of the layout design, the optical proximity correction process further altering the second portion of the layout design by displacing at least one of the plurality of edge segments within the second portion of the layout design.

20. The computer system recited in claim 18, wherein the selected edge segments are categorized based in part upon the length of the edge segment and the edge segments corner types.

21. The computer system recited in claim 20, further comprising software instructions for:
implementing an associative array corresponding to the edge segment categorization and the final displacement for each edge segment category.

22. The computer system recited in claim 21, the associative array containing a plurality of key value pairs;
each key corresponding to a length value, a corner value, a first iteration displacement, and a second iteration displacement of a selected edge segment; and
each value corresponding to the final displacement of the selected edge segment.
